(19) United States
(12) Patent Application Publication
(10) Pub. No.: US 2020/0023585 A1
(43) Pub. Date: Jan. 23, 2020

(54) DEVICE AND METHOD FOR CALIBRATING AN IRRADIATION SYSTEM USED TO PRODUCE A THREE-DIMENSIONAL WORKPIECE

(71) Applicant: SLM SOLUTIONS GROUP AG, Lübeck (DE)

(72) Inventors: Andreas Wiesner, Lübeck (DE); Toni Adam Krol, Lübeck (DE); Jan Wilkes, Lübeck (DE); Birk Hoppe, Lübeck (DE); Christiane Thiel, Lübeck (DE); Christopher Stengel, Lübeck (DE)

(21) Appl. No.: 16/486,969

(22) PCT Filed: Feb. 9, 2018
(86) PCT No.: PCT/EP2018/053264

§ 371 Date: Aug. 19, 2019

(30) Foreign Application Priority Data
Feb. 21, 2017 (DE) 10 2017 202 725.8

(51) Int. Cl. B29C 64/386; B33Y 30/00; B33Y 50/00; B29C 64/25; B28B 1/00; B23K 26/03; B23K 26/12; B23K 26/342; B23K 31/12

(52) U.S. Cl. CPC B29C 64/386; B33Y 30/00; B33Y 50/00; B29C 64/25; B23K 31/125; B23K 26/032; B23K 26/127; B23K 26/342; B28B 1/001

(57) ABSTRACT

The invention relates to a device (10) for the layered production of a three-dimensional workpiece, comprising: a build space (30) in which the workpiece is manufacturable by selectively solidification of raw material powder layers; an irradiating system (20) which is adapted to selectively solidify the raw material powder layers in the build space (30) by emitting a processing beam; at least one calibrating structure (36); a sensor arrangement (25) which is adapted to detect an irradiation of the calibrating structure (36) by the irradiating system (20); and a control unit (26) which is adapted to calibrate the irradiating system (20) on the basis of detection information of the sensor arrangement, wherein the calibrating structure (36) is arranged outside the build space (30). The invention also relates to a method for calibrating an irradiating system of a device for the layer-by-layer manufacture of a three-dimensional workpiece.

The invention relates to a device and a method for calibrating an irradiation system, wherein the irradiation system is used to manufacture a three-dimensional workpiece and is comprised by the device. In additive methods for the manufacture of three-dimensional workpieces, and in particular in additive layer building methods, it is known to solidify an initially shapeless or shape-neutral molding compound (for example a raw material powder) by location-specific irradiation and thereby bring it into a desired shape. Irradiation can take place by means of electromagnetic radiation, for example in the form of laser radiation. In a starting state, the molding compound can initially be in the form of granules, powder or a liquid molding compound and can be selectively or, in other words, location-specifically solidified as a result of the irradiation. The molding compound can comprise, for example, ceramics, metal or plastics materials and also material mixtures thereof. A variant of additive layer building methods relates to so-called powder bed fusion, in which in particular metallic and/or ceramics raw material powder materials are solidified to form three-dimensional workpieces.

In order to produce individual workpiece layers it is further known to apply raw material powder material in the form of a raw material powder layer to a carrier and to irradiate it selectively and in accordance with the geometry of the workpiece layer that is currently to be produced. The laser radiation penetrates the raw material powder material and solidifies it, for example as a result of heating, which causes fusion or sintering. Once a workpiece layer is solidified, a new layer of unprocessed raw material powder material is applied to the workpiece layer which has already been produced. Known coater arrangements or powder application devices can be used for this purpose. Irradiation is then again carried out on the raw material powder layer which is now uppermost and is as yet unprocessed. Consequently, the workpiece is gradually built up layer by layer, each layer defining a cross-sectional area and/or a contour of the workpiece. It is further known in this connection to use CAD or comparable workpiece data in order to manufacture the workpieces substantially automatically.

An example of such a device can be found in EP 1 793 979 B1. The device therein comprises a process chamber which comprises a plurality of carriers for the workpieces to be manufactured. A powder application device comprises a powder reservoir holder which can be moved forwards and backwards over the carriers in order to apply thereto a raw material powder layer to be irradiated. The process chamber is connected to a protecting gas loop, which comprises a feed line via which a protecting gas can be introduced into the process chamber in order to establish a protecting gas atmosphere therein.

An irradiation system which can be used, for example, in a device for manufacturing three-dimensional workpieces by irradiation of raw material powder materials is described in EP 2 335 848 B1. The irradiation system comprises a radiation source, in particular a laser source, and an optical unit. The optical unit, to which a processing beam emitted by the radiation source is provided, comprises a beam widening unit and a deflection device in the form of a scanner unit. Within the scanner unit, diffractive optical elements are provided in front of a deflection mirror, wherein the diffractive optical elements are movable into the beam path in order to split the processing beam into a plurality of processing sub-beams. The deflection mirror then serves to deflect the processing sub-beams.

It will be appreciated that all the aspects discussed above can likewise be provided within the framework of the present invention.

For calibrating such irradiation systems, and in particular such optical units, which are used in a device for the layer-by-layer manufacture of three-dimensional workpieces by irradiation of raw material powder materials, so-called burn-off films are often used on a carrier. The raw material powder layers to be irradiated are applied to the carrier during normal operation of the device. The burn-off film is irradiated according to a predetermined pattern, so that a burn-off image of the irradiation pattern forms on the film. The burn-off image is digitized and compared with a digital reference image of the irradiation pattern. On the basis of the result of the comparison between the digitized burn-off image and the reference image, the irradiation unit is calibrated in order to compensate for deviations between the actual burn-off image and the reference image.

A burn-off film is also used to calibrate the paths of a plurality of processing beams, in particular laser beams, which are provided in overlap zones between adjacent irradiation areas. Such irradiation areas and overlap zones formed therebetween often occur in connection with an irradiation system having a plurality of irradiation units and are, for example, in EP 2 875 897 B1 or EP 2 862 651 A1.

In principle, the thickness of a burn-off path introduced into the burn-off film, which is generated on irradiation of the film, could also be used as an indicator for measuring defocusing of the processing beam. The accuracy and the reliability of these measurements are, however, generally too low to be used for calibrating the focusing of the processing beam. Instead, additional caustic measurements are typically carried out for that purpose. Furthermore, for the calibration of irradiation systems which are used in devices for the layer-by-layer manufacture of three-dimensional workpieces, solutions are known in which calibrating plates or other specially configured calibrating elements are arranged on or parallel to a build area of the device before each calibration operation. These calibrating plates are then irradiated by the irradiation system and the reflections thereby formed are detected in order to draw conclusions about any desired-actual deviations. On the basis thereof, the irradiation system can then be calibrated. Examples thereof can be found in EP 1 048 441 A1 and in DE 10 2009 016 585 A1. However, these solutions require a high degree of manual precision when arranging the calibrating plates and are comparatively time-intensive. The inventors have recognized that a further disadvantage arises with these solutions in that calibration cannot take place during an only temporary interruption in or in parallel with a manufacturing process. Instead, the build space in these solutions must be freely available for arranging the calibrating plates. Consequently, the build space must not be occupied by an at least partially manufactured workpiece and a strict distinction must be made between the performance of a manufacturing process and the performance of a calibration operation.

Accordingly, the object of the invention is to provide a solution for calibrating an irradiation system which can be used for the layer-by-layer manufacture of a three-dimensional product, wherein this solution permits a simple but precise calibration process.

That object is achieved by a device having the features of patent claim 1 and a method having the features of patent claim 15.

Accordingly, the invention relates to a device for the layer-by-layer manufacture of a workpiece. The device can be configured to manufacture the three-dimensional workpiece in the manner of selective laser sintering. The device comprises a build space in which the workpiece is manufacturable by the layer-by-layer selective solidification of raw material powder layers. The build space can be a three-dimensional virtual space in which raw material powder layers can in a generally known manner be arranged and selectively, or in other words location-specifically, solidified. The build space can be cylindrical and/or rectangular as well as generally polygonal.

In general, the build space can define a maximum available space in the device in which a workpiece can be manufactured or, in other words, which a workpiece can occupy within the device after manufacture has taken place. In the theoretical case that the workpiece is in the form of a solid block, that block could, for example, fill the build space completely. As explained hereinbelow, the build space can comprise a build area, which in particular can form a base surface of the build space. The build area can be defined by a carrier of the device, to which the raw material powder layers can be applied by known powder application devices. The build area can define a maximum available area on which a workpiece can be manufactured, and in particular define a maximum workpiece outline that can be manufactured. Furthermore, the build area can be located opposite an irradiation system discussed hereinbelow. Overall, a known cyclic sequence of application of raw material powders, selective solidification, and fresh application of a further raw material powder layer can thus be carried out in order to build up the workpiece layer by layer.

In detail, the optional carrier of the device can be provided in a process chamber of the device. The carrier can be a generally stationary carrier or a movable carrier, which is movable in particular in the vertical direction. According to a variant, the carrier is lowered in the vertical direction as the number of manufactured workpieces increases, and preferably in dependence on that number. The process chamber can be capable of being sealed with respect to the surrounding atmosphere in order to establish a controlled atmosphere, in particular an inert atmosphere, therein. The raw material powder layer can comprise all of the above-mentioned raw material powder materials and in particular a powder of a metal alloy. The powder can have any suitable particle size or particle size distribution. A particle size of the powder of <100 μm is preferred.

As mentioned, the application of the raw material powder layer to the carrier and/or to a raw material powder layer arranged thereon and already irradiated can take place via known coater units or powder application device. An example thereof can be found in EP 2 818 305 A1.

The device further comprises an irradiation system which is adapted to selectively solidify the raw material powder layers in the build space by emitting at least one processing beam. The irradiation system can be configured to emit an electromagnetic processing beam, for example in the form of a laser beam. To that end, it can comprise suitable processing optics (or generally suitable optical units) and/or radiation sources or can be capable of being connected to such units. The processing optics can guide the processing beam and/or interact therewith in a desired manner. For this purpose they can comprise objective lenses, in particular an f-theta lens.

The irradiation system can further comprise at least one deflection device for directing the emitted processing beam onto predetermined regions within the build space and thus onto predetermined regions of the raw material powder layer that is to be irradiated. The deflection device can comprise at least one so-called scanner unit, which are preferably adjustable about at least two axes.

The irradiation system can also comprise a plurality of irradiation units, with each of which there can be associated predetermined irradiation regions within the build space. These irradiation units can each comprise in known manner their own radiation sources, processing optics and/or deflection device. Alternatively, they can be capable of being connected, for example, to a common radiation source, the emitted processing beam of which is split and provided to the individual irradiation units.

According to the invention, the device further comprises at least one calibrating structure. This can be a structure which is adapted to interact with the irradiation beam of the irradiation system in a predetermined manner so that the interaction can be detected by a sensor arrangement discussed hereinbelow. The interaction can in particular include reflections and/or absorption of the irradiation beam.

The device further comprises a sensor arrangement which is adapted to detect irradiation of the calibrating structure by the irradiation system. To that end, the sensor arrangement can comprise at least one optical detection unit, for example a camera or an image sensor. As concrete examples there may further be mentioned a photosensor, a photochip, a photodiode, a CCD sensor and a CMOS sensor. According to a variant, the sensor arrangement forms part of a known melt pool monitoring system which is used during manufacture of the workpiece. In other words, the melt pool monitoring system can instead be used at least temporarily during the performance of a calibration operation to detect the irradiation of the calibrating structure.

In general, in particular the interactions discussed above between the processing beam and the calibrating structure of the sensor arrangement can be detected. This can concern the detection of the back reflections of the processing beam (and in particular a profile over time thereof), when it is directed at the calibrating structure and/or passes over it. The sensor arrangement can thus be configured to detect the irradiation of the calibrating structure indirectly by detecting a back reflection of the radiation emitted by the irradiation system. A detection region of the sensor arrangement can for this purpose be directed at the calibrating structure and/or the build space or be capable of being selectively directed thereat. Likewise, the sensor arrangement can be located opposite any build area of the build space.

The sensor arrangement can generally be adapted to detect radiation reflected from the surroundings and in particular radiation reflected by the calibrating structure and to generate signals on the basis thereof. The signals can be further processed by a control unit of the device. The sensor arrangement can thus generally be configured to detect an intensity of the irradiation in the wavelength range of the processing beam emitted by the irradiation system. A detection region of the sensor arrangement can further generally be so chosen that it covers at least one irradiatable portion of the calibrating structure.

Primarily, the sensor arrangement can accordingly be configured to detect the reflection and/or absorption behavior in the region of the calibrating structure. In addition or alternatively, a distance measurement can also be made. The calibrating structure can thereby be detectable as a region in which the measured distance values deviate at least locally from the surroundings, that is to say, for example, are locally increased or reduced. In principle, the sensor arrangement can detect any sensor system by means of which a surface property of the calibrating structure, and in particular an interaction of that surface property with the irradiation by the irradiation system can be detected.

The detection signals of the sensor arrangement can, in a directly detected and/or in a further processed state, form detection information of the sensor arrangement. That information can be provided to control units of the device, in particular for the purpose of calibrating the irradiation system.

Concretely, the device further comprises a control unit which is adapted to calibrate the irradiation system on the basis of detection information of the sensor arrangement. The calibration can comprise a comparison of the actually detected detection information with theoretically expected detection information or, in other words, a desired-actual comparison between the detection information. If a deviation is thereby determined, in particular if that deviation exceeds a predetermined tolerance value, it can be concluded that the irradiation of the calibrating structure has not taken place in the desired manner. In particular, the control unit can be configured to draw conclusions from the detection information about an undesired relative offset between the irradiation positions on the calibrating structure specified, for example, at a predetermined time, and the actually assumed irradiation positions indicated by the detection information. This relative offset or, in other words, this desired-actual deviation, can then be used in known manner to calibrate the irradiation system. For example, the determined desired-actual deviation can be used to continuously readjust the irradiation system and/or to suitably adapt beforehand the calculation of desired values for the irradiation system (for example by including suitable correction factors).

In general, the detection information can include a profile over time of the detected radiation and in particular permit a conclusion about a time of a predetermined characteristic change in the detection signals. This change can include a signal jump. For example, for irradiation of the calibrating structure, a desired profile of, but in particular a desired change in, the detection signals at a specific time can be determined in advance. The actual detection information, on the other hand, allows a conclusion to be made about the actual profile of and in particular an actual change in the detection signals. On the basis thereof, the control unit can then carry out the above-mentioned desired-actual comparison for calibrating the irradiation system.

The device is further distinguished in that the calibrating structure is arranged outside the build space. There may be mentioned as an example an arrangement of the calibrating structure next to the build space. Accordingly, it can be provided that the calibrating structure does not interact directly with a workpiece during the process of manufacturing a workpiece, that is to say, for example, cannot be brought directly into contact therewith. In particular, the calibrating structure can permit a parallel manufacture of workpieces without them having to be removed from the device. The calibrating structure can further be arranged generally fixedly and/or substantially permanently within the device. For example, the calibrating structure can be adapted to remain in an unchanged position within the device over a manufacturing process of at least ten workpieces.

The inventors have recognized that the hitherto known calibration solutions and in particular the use of additional calibrating plates require complex manual interventions which mean a long interruption in actual workpiece production and which are susceptible to faults. The provision of a calibrating structure outside the build space, on the other hand, can make it possible that the calibrating structure can be arranged stationarily and in particular permanently within the device and needs only be irradiated selectively in order to perform a calibrating process. In other words, it can be sufficient to measure and/or correct the calibrating structure in terms of its actual position within the device before delivery of the device or at regular intervals, so that it forms a reliable reference within the device. No further manual interventions are then required for calibration. Instead, the calibrating structure can remain inside the device independently of a workpiece production and be irradiated only selectively. This even allows calibration operations to be carried out during the manufacturing process of a single workpiece, for example after a predetermined number of workpiece layers have been produced.

The calibrating structure can be arranged within a process chamber of the device. The process chamber can in known manner house the build space as well as any powder application device of the device. Likewise, the protecting gas or inert gas atmosphere can be establishable in the process chamber. The irradiation system and/or the sensor arrangement can further be arranged in a cover region of the process chamber or parallel thereto. A possible build area, on the other hand, can be arranged in or close to a base of the process chamber and be opposite the cover region. The arrangement of the calibrating structure within the process chamber can in particular take place in such a manner that the calibrating structure extends at least in part between an inner wall region of the process chamber and the build space. The inner wall region can comprise a side wall of the process chamber and/or generally face the build space. Overall, these variants can make it possible that, for the calibration, an irradiation of the calibrating structure needs only be carried out close to the build space. The irradiation system thus does not have to be formed with a significantly increased deflection spectrum and the construction of the device can be compact overall.

A further development of the invention provides that the build space comprises a build area, wherein the calibrating structure extends along at least one side of the build area. The build area can be configured according to one of the variants discussed above and formed, for example, by a surface of a carrier of the device facing the irradiation system. The build area is preferably of rectangular or circular shape. In general, the calibrating structure can extend parallel to the at least one side of the build area, wherein that side can run substantially linearly or curved. Primarily, the calibrating structure can further be of substantially elongate form and comprise, for example, a length of more than 5 cm, more than 10 cm or more than 20 cm, wherein that length can be measured in particular along a corresponding side of the build area.

Overall, it can thus be made possible that the build area must be left only slightly by the irradiation system in order to perform a calibrating operation. Accordingly, the structure of the device can be compact, and the required deflection spectrum of the irradiation system can be kept small. Likewise, the quality of the calibration can also be improved since the calibration can be performed in the immediate vicinity of the actual working region of the irradiation system and the detection signals can thus be highly meaningful for the actual processing.

The calibrating structure can comprise at least two calibrating portions which extend along different sides of the build area, in particular wherein the different sides of the build area run at an angle to one another. The sides can be opposite sides of the build area, for example opposite outer circumferential or contour portions. In particular, however, they can be opposite sides or sides which merge into one another (for example across a corner) of a substantially rectangular build area. The calibrating portions of the calibrating structure can, for example, merge into one another and/or be arranged at an angle of about 90° to one another. Both calibrating portions can further be generally elongate in form and/or have a length of more than 5 cm, more than 10 cm or more than 20 cm. Accordingly, calibration of the irradiation system can take place along at least two predetermined axes, wherein those axes can, for example, coincide with the two calibrating portions of the calibrating structure or run parallel thereto.

A further development provides that the device further comprises a base region which surrounds the build area at least in part, and wherein the calibrating structure is arranged in or parallel to the base region. The base region can comprise or be formed by a process chamber base. Likewise, the base region can define a virtual three-dimensional space, comprising the process chamber base, wherein the base region is preferably flat (i.e. has a small extent perpendicular to the process chamber base). The process chamber base can be a conventional base region of a process chamber, which is a fixed component of a machine frame of the device or is connected thereto. Furthermore, the base region can surround the build area completely and/or be arranged generally parallel thereto. The build area can be lowered within or relative to the base region by the above-described lowering of a possible carrier of the device, so that it moves apart from a surface of the base region. Primarily, the base region can form a frame structure for the build area and, optionally, be located opposite the irradiation system.

An arrangement of the calibrating structure in the base region can generally be understood as meaning an arrangement on or within the base region. The calibrating structure can accordingly be let into and/or formed within the base region. Likewise, it can be arranged on a process chamber base enclosed by the base region and be fixed thereto, for example mechanically. This can also be understood according to the invention as being an arrangement of the calibrating structure in the base region.

Likewise, the calibrating structure can also be arranged at least in part in or parallel to a side wall region of the process chamber. The side wall region can in turn be defined as a flat virtual space which is three-dimensional and comprises a side wall of the process chamber. The side wall region can extend at an angle to the base region, for example substantially orthogonally thereto. A purposive spacing of the calibrating structure from the base region can thereby be achieved, wherein the calibrating structure can, however, as before be positioned in a suitable manner relative to the sensor arrangement and the irradiation system. The distance from the base region means that severe contamination of the calibrating structure by the powder material in the build space is less likely, which in turn can have an advantageous effect on the calibration quality.

A further variant provides that the calibrating structure comprises at least in part a material whose absorption behavior, based on the irradiation of the irradiation system, differs from the absorption behavior in the surroundings of the calibrating structure. In other words, the absorption behavior in the region of the calibrating structure can be locally increased or locally reduced, so that stronger or weaker reflections of the radiation emitted by the irradiation system occur. This can in turn be detected by the sensor arrangement.

In general, the absorption behavior can relate to light and/or electromagnetic radiation in the wavelength range of the radiation emitted by the irradiation system.

Preferably, the material has an increased absorption behavior relative to the surroundings, so that a back reflection of the radiation in the region of the calibrating structure is less than in the region of the immediate surroundings thereof. The surroundings can be provided by the above-mentioned base region of the device and have no such material. In general, the material can be in the form of a coating which is applied at least in part to the calibrating structure.

In general, the calibrating structure can comprise or form a suitable surface structure which can be detected by the sensor arrangement as differing from the surroundings. According to one example, the calibrating structure comprises at least one elevation, wherein the irradiation system is adapted to carry out an irradiation of the calibrating structure in the region of the elevation in the context of a calibration operation. The elevation can be a portion that is elevated in comparison with the surroundings of the calibrating structure, for example a local protuberance.

In addition or alternatively, the calibrating structure can further comprise at least one depression, wherein the irradiation system is adapted to carry out an irradiation of the calibrating structure in the region of the depression in the context of a calibration operation. When arranged in the base region of the device, the calibrating structure can be in the form of a depression in that base region. The depression can generally comprise a recess, an opening, a groove or a hole, which are produced, for example, by cutting. When the irradiation system passes over the calibrating structure, a change in the reflection behavior of the radiation emitted by the irradiation system can thus take place due to the changing surface conditions in the region of the depression. This can in turn be detected by the sensor arrangement.

Preferably, the material for influencing the absorption behavior is arranged close to or in a transition region between the depression and/or elevation and the surroundings of the calibrating structure. This makes it possible that the reaching of the depression and/or elevation can be detected particularly accurately, since an interaction with the radiation by the irradiation system changes there in a particularly large-scale and thus easily detectable manner.

The depression and/or elevation can further comprise at least one edge, preferably at an upper edge and/or in a transition region to the surroundings of the calibrating structure. The edge can be comprised by a sharp-edged region of the depression and/or elevation or can form that region. It can be the transition between the surroundings and the depression and/or elevation, which is sharp-edged or only slightly rounded. Accordingly, the edge can be delimited by a surface of the surroundings, for example in the form of a base region surface, as well as by an inside wall of the depression and/or outside wall of the elevation that is angled away from that surface. This inside or outside wall can extend substantially orthogonally to the mentioned surface. The depression and/or elevation can thus generally be substantially step-shaped. The provision of such an edge likewise permits a large-scale change in the interaction between the irradiation and the calibrating structure, which is advantageous for detection by the sensor arrangement.

According to a further development, the depression and/or elevation comprises a main portion, which extends substantially along the build area, and the depression and/or elevation further comprises at least one secondary portion, which extends at an angle to the main portion. The main portion can extend in the above-described manner along one side of the build area, for example along one side of a rectangular build area. The main portion can also have an angled profile, that is to say, for example, extend along a corner region of the build area and enclose that region at least in part. Furthermore, the main portion can generally be of elongate form and have, for example, a length of more than 5 cm, more than 10 cm or more than 20 cm. The secondary portion, on the other hand, can have a shorter length compared to the main portion, for example a length of less than 10 cm or less than 5 cm. Furthermore, the secondary portion can extend along an axis which runs at an angle to a longitudinal axis of the main portion, for example at an angle of more than 45° and in particular substantially orthogonally to the longitudinal axis. The secondary portion and the main portion can thus define substantially a cross shape.

An advantage of forming the depression and/or elevation with such main and secondary portions is that a more comprehensive calibration is made possible. Thus, a first main irradiation axis, along which irradiation is carried out, can extend parallel to the main portion. A second main irradiation axis, on the other hand, which runs at an angle to the first main irradiation axis and preferably orthogonal thereto, can extend parallel to the secondary portions. In particular where there are a plurality of secondary portions, calibration along the second main irradiation axis can thus be carried out along different positions of the first main irradiation axis by travelling on a corresponding secondary portion. Overall, the robustness and meaningfulness of the calibration can thus be increased.

In this connection it can further be provided that a plurality of secondary portions are provided, which are preferably arranged at regular intervals along the main portion. For example, more than two, more than four, more than six or more than eight secondary portions can be provided along the main portion, which secondary portions are spaced apart from one another along a longitudinal axis of the main portion by from approximately 2 to approximately 10 cm.

A further development provides that the sensor arrangement is configured to detect the entry and/or exit of the processing beam into or out of the depression and/or wherein the sensor arrangement is configured to detect the reaching and/or leaving of the elevation. This can be determined by the above-mentioned change in the reflection behavior of the irradiation as it passes over the depression or elevation. For example, the sensor arrangement can be adapted to detect an at least temporary reduction and/or an at least temporary increase in the reflected radiation, when it is directed within the scope of a calibration process into the region of the depression or elevation and preferably also performs a predetermined movement within that region. The reduction in the reflected radiation (and/or the detection of an increased distance value) can indicate entry into the depression, whereas the increase in the reflected radiation (and/or the detection of a smaller distance value) can indicate exit from the depression. Likewise, the increase in the reflected radiation (and/or the detection of a smaller distance value) can indicate reaching of the elevation, whereas the reduction of the reflected radiation (and/or the detection of an increased distance value) can indicate leaving of the elevation.

The irradiation system can further be configured to emit a processing beam with a power that does not have solidifying action at least during a calibration operation. In other words, the power and/or intensity of the processing beam during the calibration operation can be reduced as compared with a power that is used to manufacture a workpiece from the raw material powder layers. The power of the processing beam during the calibration process can be not more than 10%, not more than 5% or not more than 1% of the power having solidifying action. Undesirable damage to the calibrating structure can thereby be avoided. Furthermore, the detection region of the sensor arrangement can specifically be adapted to that power spectrum and/or the accompanying intensity spectrum of any back reflections from the calibrating structure, so that a risk of incorrect detections during the calibration operation is reduced.

In order to reduce the power of the processing beam, so-called beam traps or beam splitters can selectively be arranged in the beam path of the processing beam. These can comprise, for example, gray filters, in order deliberately to weaken the processing beam. In addition or alternatively, it is possible to adjust a power of the radiation source or to use separate radiation sources, which are provided specifically for calibration purposes.

The invention relates further to a method for calibrating an irradiation system of a device for the layer-by-layer manufacture of a three-dimensional workpiece, wherein the device in particular according to any one of the preceding claims, wherein the method comprises the following steps:
irradiating a calibrating structure outside a build space, wherein the irradiation takes place by means of an irradiation system and the workpiece is manufacturable in the build space by selective solidification of raw material powder layers;
detecting the irradiation of the calibrating structure;
calibrating the irradiation system based on the detected irradiation of the calibrating structure.

The method further comprise any further steps and features for providing the effects and interactions mentioned hereinabove and hereinbelow. In particular, the method can comprise a step of arranging the calibrating structure relative to a build area according to one of the variants above or below. Likewise, the method can comprise irradiating the calibrating structure by guiding a processing beam of the irradiation system along a predetermined path.

The method can further comprise steps for evaluating the detection information obtained, wherein the evaluation can comprise any of the variants described hereinabove or hereinbelow for determining predetermined changes. The step of detecting the irradiation of the calibrating structure can comprise a step of detecting back reflections produced thereby and in particular determining a profile over time thereof. The evaluation can then concern the determination of predetermined changes in that profile over time, for example in order to determine therefrom the reaching and/or leaving of the calibrating structure. Finally, the calibrating step can comprise performing a desired-actual comparison, as discussed hereinbefore.

The invention will be explained hereinbelow with reference to the accompanying figures, in which:

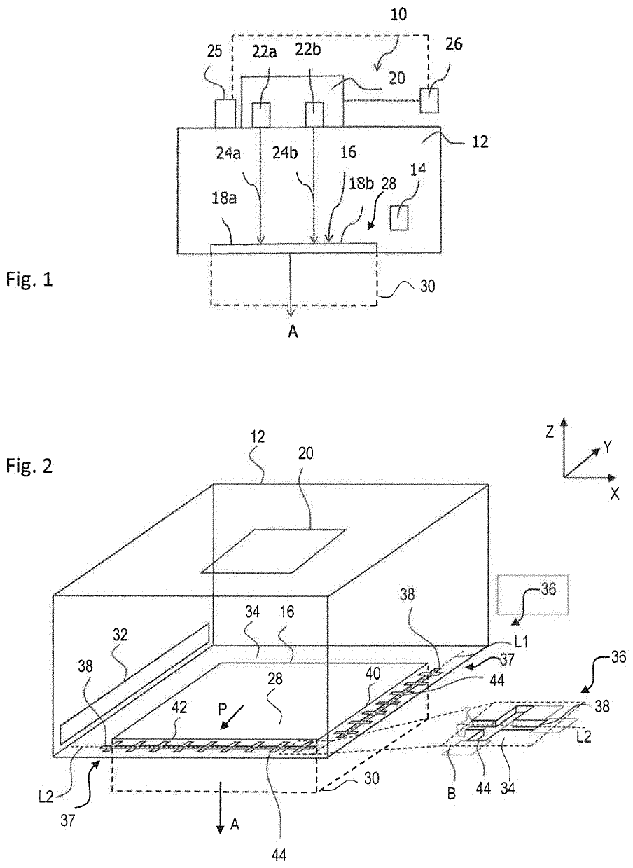

FIG. 1: is a view of a device according to the invention which performs a method according to the invention;

FIG. 2: is a perspective view of a process chamber of the device of FIG. 1; and

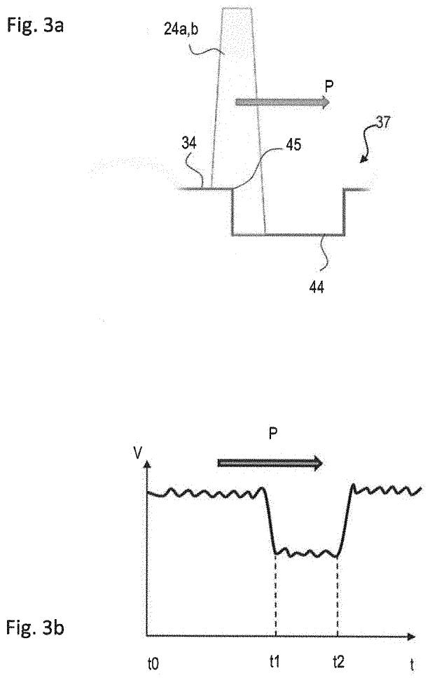

FIGS. 3a, 3b: are schematic representations of the detection operation and of the profile over time of the detection signals in the device of FIG. 1.

FIG. 1 shows a device 10 which is configured to carry out a method according to the invention for the additive manufacture of three-dimensional workpieces from a metallic powder bed. More precisely, the method relates to a manufacturing process in the manner of so-called selective laser melting (SLM). The device 10 comprises a process chamber 12. The process chamber 12 can be sealed with respect to the atmosphere so that an inert gas atmosphere can be established therein. A powder application device 14, which is arranged in the process chamber 12, applies raw material powder layers to a carrier 16. As shown in FIG. 1 by an arrow A, the carrier 16 is adapted to be displaced in a vertical direction. The carrier 16 can thus be lowered in the vertical direction as the build height of the workpiece increases, when the workpiece is built up layer by layer from the selectively solidified raw material powder layers.

The device 10 further comprises an irradiation system 20 for selectively and location-specifically directing a plurality of laser beams 24a,b onto the raw material powder layers on the carrier 16. More precisely, the raw material powder material can be exposed to radiation by means of the irradiation system 20 in accordance with a geometry of a workpiece layer that is to be produced, and thus locally melted and solidified. The irradiation of the raw material powder layers by the irradiation system 20 is thereby controlled by a control unit 26.

In the exemplary embodiment shown, the irradiation system comprises two irradiation units 22a,b, which together can irradiate the raw material powder material. It is, however, also conceivable to provide only one such irradiation unit 22a,b or a plurality of irradiation units 22a,b arranged, for example, in a matrix.

Each of the irradiation units 22a,b shown is coupled to a common laser beam source. The laser beam emitted by the laser beam source can be split and/or deflected by suitable means, such as, for example, beam splitters and/or mirrors, in order to guide the laser beam to the individual irradiation units 22a,b. Alternatively, it would be conceivable to allocate each of the irradiation units 22a,b its own laser beam source. A suitable laser beam source can be provided, for example, in the form of a diode-pumped ytterbium fiber laser having a wavelength of approximately from 1070 to 1080 nm.

Each of the irradiation units 22a,b further comprises a processing beam optics, in order to interact with the laser beam provided. The processing optics each comprise a deflection device in the form of a scanner unit, which is able flexibly to position the focus point of the laser beam 24a,b emitted in the direction of the carrier 16 within an irradiation plane extending parallel to the carrier 16.

The surface of the carrier 16 facing the irradiation system 20 forms a build area 28, which defines a maximum possible base area or, in other words, a maximum cross-sectional area of the workpiece which can be produced. The build area 28 is of generally rectangular shape. A position of the build area 28 within the process chamber 12 can further be varied according to a lowering of the carrier 16. The build area 28 further forms the base area of a three-dimensional virtual build space 30 of the device 10, in which the workpiece can be manufactured. Owing to the described movement of the build area 28, the build space 30 is generally cylindrical with a correspondingly rectangular base area. An extent of the build space 30 is further shown in FIGS. 1 and 2 by a broken line.

Finally, a sensor arrangement 25 is shown schematically in FIG. 1, which sensor arrangement is able to detect back reflections of the laser beams 24a,b from the build area 28 and the surroundings. The sensor arrangement 25 is likewise connected to the control device 26 of the device 10. It is to be noted that the positioning of the sensor arrangement 25 shown is merely by way of example. In particular when the sensor arrangement 25 is in the form of a constituent of an existing melt pool monitoring system, it can instead be integrated in the beam path of the irradiation system 20 or interact at least indirectly therewith. A so-called “in-line” measurement of the back-reflected radiation can thus be carried out.

In FIG. 2, the process chamber 12 is shown in perspective, wherein the powder application device 14 has been omitted, however. There will again be seen the carrier 16, which forms the build area 28. The build space 30 is again defined as a cylinder with a rectangular base. The irradiation system 20 is indicated in FIG. 2 as a merely schematic rectangle and is generally configured selectively to irradiate the raw material powder layer within the build area 28. In FIG. 2 there is additionally shown gas outlet 32, which forms a known component of a process gas loop (not shown) of the device 10, in order to establish a protecting gas atmosphere within the process chamber 12.

It will be seen that the process chamber 12 comprises a base region 34. The base region is generally planar and extends parallel to the build area 28. The base region 34 is formed by a conventional base plate of the device 10, which is connected to a machine frame (not shown) and which is located generally opposite the irradiation system 20. In the starting state shown, in which the carrier 16 and thus the build area 28 have not yet been lowered, a surface of the base region 34 is further flush with the build area 28. The base region 34 overall forms a frame structure around the build area 28.

Within the base region 34 there is provided a calibrating structure 36, comprising two calibrating portions 37. The calibrating portions are in the form of depressions within the base region 34 and, more precisely, in the form of elongate recesses formed by cutting. This is clear from the enlarged partial view B in FIG. 2, which shows an end portion of one of the calibrating portions 37. It is also conceivable to provide a calibrating structure 36 having only one such calibrating portion 37.

The calibrating portions 37 each comprise a main portion 38 which extends along a longitudinal axis L1, L2. The calibrating portions 37 or, in other words, the main portions 38 thereof are further arranged substantially orthogonally to one another. Concretely, it will be seen in FIG. 2 that the main portions 38 extend along and parallel to different side regions of the rectangular build area 28. This relates to a first side 40 and a second side 42 of the rectangular build area 28, which run orthogonally to one another. Figuratively speaking, the calibrating portions 37 accordingly extend “across a corner”, based on the build area 28. With regard to the position of the calibrating portions 37, FIG. 2 also shows that these are arranged between an inner side wall region of the process chamber 12 facing the build area 28 and the build area 28. They are at only a small distance of a few centimeters from the build area 28.

It will further be seen in FIG. 2 that each of the calibrating portions 37 comprises a plurality of secondary portions 44, which are distributed at regular intervals along the main portions 38. In the example of FIG. 2, each of the calibrating portions 37 comprises more than six such secondary portions 44. For reasons of representation, not all the secondary portions 44 are provided with a corresponding reference numeral. As further becomes clear from the detail view in FIG. 2, the secondary portions 44 are likewise in the form of depressions and extend orthogonally to the main portion 38, wherein the secondary portions 44 are divided in the middle by the longitudinal axes L1, L2 of the main portions.

The secondary portions 44 thus form depression portions running transversely to the main portions 38, so that the calibrating portions 37 are each composed of individual cross-shaped depression regions along their respective longitudinal axes L1, L2.

In order to carry out a calibration operation, the control unit 26 causes the irradiation system 20 to direct a processing beam in the form of one of the laser beams 24a,b from FIG. 1 according to a predetermined movement path onto at least one of the calibrating portions 37. In particular, the processing beam, which is provided during the calibration with a deliberately reduced power which does not have solidifying action, can first be directed onto a surface of the base region 34, which surrounds the calibrating structure 36, and then be moved in the direction of one of the calibrating portions 37. The sensor arrangement 25 can, parallel thereto, detect the back reflections of the radiation from the base region 34 and/or the calibrating structure 36.

When the processing beam passes from the surface of the base region 34 for the first time into one of the calibrating portions 37 and into the depression formed thereby, the intensity of the back reflections detected by the sensor arrangement changes. This is further assisted in the present case in that the side and bottom walls of the calibrating portions 37 are each coated with a material which absorbs at least some of the laser radiation. The absorption of the laser radiation by that material is further greater than the absorption that occurs at the surface of the base region 34 surrounding the calibrating portions 37.

A profile over time of the signals detected by the sensor arrangement 25 is shown in FIGS. 3a,b. FIG. 3a shows a situation in which a laser beam 24a,b emitted by the irradiation system 20 passes for the first time into one of the secondary portions 44 of one of the calibrating portions 37. A movement path P on which this occurs is likewise indicated in FIG. 2. It will further be seen in FIG. 3a that the calibrating portions 37 form step-like depressions within the base region 34 and thus comprise sharp-edged transitions in the form of edges 45. Similarly to the absorbing material described hereinbefore, these lead to a particularly marked change in the reflection behavior on entry into the calibrating portions 37, which can be detected particularly reliably by the sensor arrangement 25.

FIG. 3b shows a profile over time of a sensor signal of the sensor arrangement 25 during this operation, wherein the sensor signal is shown by way of example as a sensor voltage V. Up to time t1, the laser beam 24a,b is moved along the planar surface of the base region 34, so that its back reflection does not change. The sensor signal of the sensor arrangement 25 is therefore substantially constant in the time period t0 to t1. At time t1, the laser beam 24a,b enters the secondary portion 44 forming a depression, so that its back reflection behavior changes suddenly and in the example shown falls suddenly. This also manifests itself in a change in the sensor signal at that time. Likewise, a reverse change of the sensor signal occurs when the laser beam 24a,b leaves the secondary portion 44 again at time t2. Between times t1 and t2 and also from time t2, the sensor signal is substantially constant, although at different voltage levels.

In summary, it will thus be seen that the control unit 26 is able to determine from the sensor signal of the sensor arrangement 25 the entry time t1 and also the exit time t2 from a region having an overbar (here: secondary portion 44) of the calibrating structure 36. Likewise, the parameters of the irradiation system 20 can be determined at that point in time, for example a current deflection position of the processing beam at the particular points in time in question. Since the position and extent of the calibrating structure 36 and in particular of the individual calibrating portions 37 thereof within the device 10 are known and generally unchangeable, it can thus be checked whether the determined times t1, t2 correspond to expected desired time points for particular specified irradiation parameters.

If that is not the case, this is an indication that the irradiation system 20 is not irradiating the calibrating structure 36 as expected, that is to say, for example because of too small a deflection, the calibrating portions 37 are not being reached at the expected times. The control unit 26 can then carry out a desired-actual comparison between the specified and the actually determined irradiation behavior and, on the basis thereof, calibrate the irradiation system 20 in order to compensate for a desired-actual deviation which may be determined.

Such a deviation, which suggests, for example, too early or too late entry into or exit from the calibrating portions 37, can lead to the conclusion that a deflection of the processing beam is not taking place in the desired manner and/or that there is a relative offset between the irradiation system 20 and the calibrating structure 36 which has not been taken into account. Such a relative offset also relates to a relative offset between the irradiation system 20 and the build area 28, since it can be assumed with sufficient accuracy that the relative position of the build area 28 and the calibrating structure 36 is known and constant. This offset can be compensated for by calibrating the irradiation system 20, for example by a suitable readjustment of the deflection of the processing beam and/or by calculating beforehand correspondingly adapted control signals for the irradiation system 20.

By arranging the calibrating portions 37 along two orthogonal sides of the build area 28 (or along the X-Y-axes of the build area 28 according to a conventional axis definition), the irradiation system 20 can thus reliably be calibrated relative to the build area 28. The plurality of secondary portions 44 thereby permits calibration in a plurality of predetermined positions along the corresponding sides of the build area 28.

1-14. (canceled)

15. A device for the layer-by-layer manufacture of a three-dimensional workpiece, comprising:
a build space in which the workpiece is manufacturable by selective solidification of raw material powder layers;
an irradiation system which is adapted to selectively solidify the raw material powder layers in the build space by emitting at least one processing beam;
at least one calibrating structure;
a sensor arrangement which is adapted to detect a back reflection of irradiation emitted by the irradiation system at the calibrating structure; and
a control unit (26) which is adapted to calibrate the irradiation system on the basis of detection information of the sensor arrangement,
wherein the calibrating structure is arranged outside the build space, and
wherein the calibrating structure comprises at least one depression and/or elevation, and
wherein the irradiation system is adapted to carry out irradiation of the calibrating structure in the region of the depression and/or elevation within the context of a calibration operation.

16. The device as claimed in claim 15, wherein the calibrating structure is arranged within a process chamber of the device, in particular in such a manner that it extends at least in part between an inner wall region of the process chamber and the build space.

17. The device as claimed in claim 15, wherein the build space comprises a build area, wherein the calibrating structure extends along at least one side of the build area.

18. The device as claimed in claim 17, wherein the calibrating structure comprises at least two calibrating portions which extend along different sides of the build area, in particular wherein the different sides of the build area run at an angle to one another.

19. The device as claimed in claim 17, wherein the device further comprises a base region which surrounds the build area (28) at least in part, and wherein the calibrating structure is arranged in or parallel to the base region.

20. The device as claimed in claim 16, wherein the calibrating structure is arranged at least in part in or parallel to a side wall region of the process chamber.

21. The device as claimed in claim 15, wherein the calibrating structure comprises at least in part a material whose absorption behavior, based on the irradiation of the irradiation system, differs from the absorption behavior in the surroundings of the calibrating structure.

22. The device as claimed in claim 21, wherein the material for influencing the absorption behavior is arranged close to or in a transition region between the depression and/or elevation and the surroundings of the calibrating structure.

23. The device as claimed in claim 15, wherein the depression comprises at least one edge, preferably at an upper edge and/or in a transition region to the surroundings of the calibrating structure.

24. The device as claimed in claim 17, wherein the depression and/or elevation comprises a main portion which extends substantially along the build area, and wherein the depression and/or elevation comprises at least one secondary portion which extends at an angle to the main portion.

25. The device as claimed in claim 24, wherein there are provided a plurality of secondary portions which are arranged preferably at regular intervals along the main portion.

26. The device as claimed in claim 15, wherein the sensor arrangement is configured to detect the entry and/or exit of the processing beam into or out of the depression, and/or wherein the sensor arrangement is configured to detect the reaching and/or leaving of the elevation.

27. The device as claimed in claim 15, wherein the control system is configured to control the irradiation system in such a manner that, at least during a calibration operation, the irradiation system emits a processing beam with a power that does not have solidifying action.

28. A method for calibrating an irradiation system of a device for the layer-by-layer manufacture of a three-dimensional workpiece, wherein the device is configured in particular as claimed in claim 15, wherein the method comprises the following steps:
irradiating a calibrating structure outside a build space, wherein the irradiation takes place by means of an irradiation system and the workpiece is manufacturable in the build space by selective solidification of raw material powder layers;
detecting a back reflection of an irradiation emitted by the irradiation system at the calibrating structure;
calibrating the irradiation system on the basis of the detected back reflection of the irradiation emitted by the irradiation system at the calibrating structure,
wherein the calibrating structure comprises at least one depression and/or elevation, and
wherein the irradiation system is adapted to carry out irradiation of the calibrating structure in the region of the depression and/or elevation within the context of a calibration operation.
